(19) United States
(12) Patent Application Publication
(10) Pub. No.: US 2026/0241535 A1
(43) Pub. Date: Aug. 20, 2026

(54) SYSTEM, METHOD, AND APPARATUS FOR MODELING CORRELATING PHYSICAL CONTACT TO PERFORMANCE

(71) Applicant: MISSION SUPPORT AND TEST SERVICES, LLC, Las Vegas, NV (US)

(72) Inventor: Scott SONNON, Las Vegas, NV (US)

(21) Appl. No.: 19/539,286

(22) Filed: Feb. 13, 2026

Related U.S. Application Data
(60) Provisional application No. 63/758,771, filed on Feb. 14, 2025.

(51) Int. Cl. B25G 1/00; G01L 5/00; G01L 5/22; G09B 5/02

(52) U.S. Cl. CPC B25G 1/00; G01L 5/0038; G01L 5/22; G09B 5/02

(57) ABSTRACT

Embodiments generally relate to a system, method, and apparatus for a computational model that integrates pressure sensor data synchronized with an outcome measure of performance. A method is provided including: determining locations on a handle portion of a device receiving pressure at respective pressure sensors responsive to a user interaction with the handle portion; determining a magnitude of pressure received at each of the respective pressure sensors responsive to the user interaction; comparing the locations on the handle portion receiving pressure at the respective pressure sensors and the magnitude of the pressure received at each of the respective pressure sensors with a pressure profile corresponding to a threshold performance metric; and providing for presentation at a user interface of pressure at the respective pressure sensors and the magnitude of the pressure received at each of the respective pressure sensors relative to the pressure profile corresponding to the threshold performance metric.

### CROSS-REFERENCE TO RELATED APPLICATIONS

This application claims priority to U.S. Provisional Patent Application Ser. No. 63/758,771, filed on Feb. 14, 2025, the contents of which are hereby incorporated by reference in their entirety.

### STATEMENT OF GOVERNMENT SUPPORT

This invention was made with government support under contract DE-NA0003624 awarded by the U.S. Department of Energy, National Nuclear Security Administration. The government has certain rights in the invention.

### TECHNOLOGICAL FIELD

Embodiments of the present disclosure relate generally to measurement of human performance, and more particularly, to a system, method, and apparatus for a computational model that integrates pressure sensor data synchronized with an outcome measure of performance.

### BACKGROUND

Various devices and systems exist for evaluating user actions for predicting performance. This can include analyzing movement of a user through cameras, body-worn sensors, or other devices. Such systems are of limited reliability when tactile contact dynamics are not time-synchronized with outcome measures.

### BRIEF SUMMARY

A system, apparatus, and method are provided herein for measurement and prediction of human performance, and more particularly, to a system, method, and apparatus for a computational model that integrates pressure sensor data synchronized with an outcome measure of performance. According to an example embodiment, a model is generated through the use of pressure profiles of a user's engagement with a device, and the pressure profiles are time synchronized with the outcome to measure performance. The optimum performance is correlated to corresponding pressure profiles, and those pressure profiles can then be used to guide a user's engagement with the device to improve an outcome of the user's action on the device.

Embodiments provide a pressure sensitive training apparatus including: a handle portion of a device, wherein the device is configured to cause an action responsive to a user interaction with the handle portion of the device; a plurality of pressure sensors disposed about the handle portion of the device; and a controller, wherein the controller is configured to: determine locations on the handle portion receiving pressure at respective pressure sensors responsive to the user interaction; determine a magnitude of pressure received at each of the respective pressure sensors responsive to the user interaction; compare the locations on the handle portion receiving pressure at the respective pressure sensors and the magnitude of the pressure received at each of the respective pressure sensors with a pressure profile corresponding to a threshold performance metric; and provide for presentation at a user interface of pressure at the respective pressure sensors and the magnitude of the pressure received at each of the respective pressure sensors relative to the pressure profile corresponding to the threshold performance metric.

According to some embodiments the user interaction with the handle portion of the device comprises an action performed by a user while grasping the handle portion of the device. The device of an example embodiment includes a piece of athletic equipment or other hand-operated device, and wherein the user interaction comprises swinging, actuating, or manipulating the device. According to certain embodiments the threshold performance metric includes a measure of performance that corresponds with an athletic event above a predetermined precision.

According to some embodiments the athletic event above a predetermined precision includes an athletic event having a result that is within the predetermined precision of an athletic event identified as ideal. The controller configured to determine the locations on the handle portion receiving pressure at respective pressure sensors responsive to the user interaction is further configured, in some embodiments, to determine the locations over a time period duration of the user interaction. The controller configured to determine the magnitude of pressure received at each of the respective pressure sensors responsive to the user interaction is further configured, in some embodiments, to determine the magnitude over the time period duration of the user interaction.

The controller configured to provide for presentation at the user interface is further configured, in some embodiments, to provide the presentation over the time period duration of the user interaction. The controller of some embodiments is further configured to segment pressure data associated with the user interaction into a plurality of temporal phases over the time period duration of the user interaction, and to correlate pressure data from at least one of the plurality of temporal phases more heavily with the threshold performance metric than pressure data from another of the plurality of temporal phases. The controller of certain embodiments is further configured to update the pressure profile corresponding to the threshold performance metric based on pressure data associated with subsequent user interactions that satisfy the threshold performance metric.

The controller configured to provide for presentation at the user interface is further configured to, in some embodiments, provide a graphical illustration of the handle portion of the device and the user interaction with the handle portion of the device. According to some embodiments the controller configured to provide the graphical illustration is further configured to distinguish identified locations of the handle portion where the user interaction fails to correspond with the pressure profile corresponding to the threshold performance metric.

According to some embodiments the an outcome measure of performance includes a plurality of heterogeneous sensor modalities, where the controller is configured to time-synchronize pressure data with data from at least two different sensor modalities when determining correspondence with the threshold performance metric. The user interface of certain embodiments is further configured to present a replay of the user interaction synchronized with the pressure data and the outcome measure of performance. The controller of some embodiments is further configured to detect a deviation of the pressure data from a baseline pressure profile indicative of user degradation and to generate an alert responsive to the detected deviation.

Embodiments provide a method including: determining locations on a handle portion of a device receiving pressure at respective pressure sensors responsive to a user interaction with the handle portion of the device; determining a magnitude of pressure received at each of the respective pressure sensors responsive to the user interaction; comparing the locations on the handle portion receiving pressure at the respective pressure sensors and the magnitude of the pressure received at each of the respective pressure sensors with a pressure profile corresponding to a threshold performance metric; and providing for presentation at a user interface of pressure at the respective pressure sensors and the magnitude of the pressure received at each of the respective pressure sensors relative to the pressure profile corresponding to the threshold performance metric.

According to some embodiments the user interaction with the handle portion of the device includes an action performed by the a user while grasping the handle portion of the device. According to some embodiments the device includes a piece of athletic equipment, wherein the user interaction comprises swinging the device, or wherein the device comprises a non-athletic hand-operated device. According to certain embodiments the threshold performance metric includes a measure of performance that corresponds with an athletic event above a predetermined precision. According to some embodiments determining the locations and determining the magnitude are performed over a time period duration of the user interaction.

According to some embodiments providing for presentation at the user interface is performed over the time period duration of the user interaction. The method of some embodiments further includes segmenting the pressure data associated with the user interaction into a plurality of temporal phases over the time period duration of the user interaction, and correlating pressure data from at least one of the plurality of temporal phases more heavily with the threshold performance metric than pressure data from another of the plurality of temporal phases.

The method of certain embodiments further includes updating the pressure profile corresponding to the threshold performance metric based on pressure data associated with subsequent user interactions that satisfy the threshold performance metric. According to some embodiments providing for presentation at the user interface includes providing a graphical illustration of the handle portion of the device and the user interaction with the handle portion of the device. According to certain embodiments providing the graphical illustration comprises distinguishing identified locations of the handle portion where the user interaction fails to correspond with the pressure profile corresponding to the threshold performance metric.

The method of some embodiments further includes time-synchronizing the pressure data with data from at least two different outcome sensor modalities when determining correspondence with the threshold performance metric. The method of certain embodiments further includes detecting a deviation of the pressure data from a baseline pressure profile indicative of user degradation and generating an alert responsive to the detected deviation.

Embodiments provide a non-transitory computer-readable medium storing instructions that, when executed by one or more processors, cause the one or more processors to: determine locations on a handle portion of a device receiving pressure at respective pressure sensors responsive to a user interaction with the handle portion of the device; determine a magnitude of pressure received at each of the respective pressure sensors responsive to the user interaction; compare the locations on the handle portion receiving pressure at the respective pressure sensors and the magnitude of the pressure received at each of the respective pressure sensors with a pressure profile corresponding to a threshold performance metric; and provide for presentation at a user interface of pressure at the respective pressure sensors and the magnitude of the pressure received at each of the respective pressure sensors relative to the pressure profile corresponding to the threshold performance metric.

Embodiments provide a pressure sensitive training apparatus including: a handle portion of a device, where the device is configured to cause an action responsive to a user interaction with the handle portion of the device; a plurality of pressure sensors disposed about the handle portion of the device; a controller, where the controller is configured to: determine locations on the handle portion receiving pressure at respective pressure sensors responsive to the user interaction; determine a magnitude of pressure received at each of the respective pressure sensors responsive to the user interaction; compare the locations on the handle portion receiving pressure at the respective pressure sensors and the magnitude of the pressure received at each of the respective pressure sensors with a pressure profile corresponding to a threshold performance metric; and provide for presentation at a user interface of pressure at the respective pressure sensors and the magnitude of the pressure received at each of the respective pressure sensors relative to the pressure profile corresponding to the threshold performance metric.

According to some embodiments the user interaction with the handle portion of the device comprises an action performed by the user while grasping the handle portion of the device. According to certain embodiments apparatus includes a piece of athletic equipment, wherein the user interaction comprises swinging apparatus. The threshold performance metric of some embodiments includes a measure of performance that corresponds with an athletic event above a predetermined precision. According to some embodiments the athletic event above a predetermined precision comprises an athletic event having a result that is within the predetermined precision of an athletic event identified as ideal.

The controller configured to determine the locations on the handle portion receiving pressure at respective pressure sensors responsive to the user interaction includes, in some embodiments, the controller configured to: determine locations on the handle portion receiving pressure at respective pressure sensors responsive to the user interaction over a time period duration of the user interaction. The controller configured to determine the magnitude of pressure received at each of the respective pressure sensors responsive to the user interaction includes, in certain embodiments, the controller configured to: determine a magnitude of pressure received at each of the respective pressure sensors responsive to the user interaction over the time period duration of the user interaction.

According to some embodiments the controller configured to provide for presentation at the user interface of pressure at the respective pressure sensors and the magnitude of the pressure received at each of the respective pressure sensors relative to the pressure profile corresponding to the threshold performance metric includes the controller configured to: provide for presentation at a user interface of pressure at the respective pressure sensors and the magnitude of the pressure received at each of the respective pressure sensors relative to the pressure profile corresponding to the threshold performance metric over the time period duration of the user interaction.

In one representative embodiment, the Shoot-Move-and-Communicate (SMAC) sensor suite constitutes a physical instantiation of the Deliberate Practice and Feedback (DPAF) computational architecture described herein. In such embodiments, SMAC provides a tangible sensor-level implementation in which pressure sensors, inertial movement units, and optional recoil or force-simulation components collectively function as a physical observability layer. The DPAF computational model operates as an abstraction layer that time-synchronizes physical contact data with outcome measures of performance, identifies statistically significant performance-correlated events, and generates feedback signals for guiding subsequent user interaction. While SMAC is described in the context of marksmanship training, it is to be understood that SMAC is exemplary rather than limiting, and that the DPAF architecture is application-agnostic and may be instantiated across a wide range of human-equipment interaction domains.

According to certain embodiments the controller configured to provide for presentation at the user interface of pressure at the respective pressure sensors and the magnitude of the pressure received at each of the respective pressure sensors relative to the pressure profile corresponding to the threshold performance metric includes the controller configured to: provide a graphical illustration of the handle portion of the device and the user interaction with the handle portion of the device.

The controller configured to provide a graphical illustration of the handle portion of the device and the user interaction with the handle portion of the device includes, in some embodiments, the controller configured to: provide a graphical illustration of identified locations of the handle portion of the device where the user interaction with the handle portion of the device is determined to fail to correspond with the pressure profile corresponding to the threshold performance metric in manner that distinguishes the identified locations of the handle portion from a remainder of the handle portion.

Embodiments provide a method including: determining locations on a handle portion of a device receiving pressure at respective pressure sensors responsive to a user interaction with the handle portion of the device; determining a magnitude of pressure received at each of the respective pressure sensors responsive to the user interaction; comparing the locations on the handle portion receiving pressure at the respective pressure sensors and the magnitude of the pressure received at each of the respective pressure sensors with a pressure profile corresponding to a threshold performance metric; and providing for presentation at a user interface of pressure at the respective pressure sensors and the magnitude of the pressure received at each of the respective pressure sensors relative to the pressure profile corresponding to the threshold performance metric.

According to some embodiments the user interaction with the handle portion of the device comprises an action performed by the user while grasping the handle portion of the device. According to certain embodiments the device comprises a piece of athletic equipment, wherein the user interaction comprises swinging device. The threshold performance metric of certain embodiments includes a measure of performance that corresponds with an athletic event above a predetermined precision. According to some embodiments the athletic event above a predetermined precision includes an athletic event having a result that is within the predetermined precision of an athletic event identified as ideal.

According to certain embodiments, determining the locations on the handle portion receiving pressure at respective pressure sensors responsive to the user interaction includes: determining locations on the handle portion receiving pressure at respective pressure sensors responsive to the user interaction over a time period duration of the user interaction. Determining the magnitude of pressure received at each of the respective pressure sensors responsive to the user interaction includes, in some embodiments, determining a magnitude of pressure received at each of the respective pressure sensors responsive to the user interaction over the time period duration of the user interaction.

Providing for presentation at the user interface of pressure at the respective pressure sensors and the magnitude of the pressure received at each of the respective pressure sensors relative to the pressure profile corresponding to the threshold performance metric includes, in some embodiments, providing for presentation at a user interface of pressure at the respective pressure sensors and the magnitude of the pressure received at each of the respective pressure sensors relative to the pressure profile corresponding to the threshold performance metric over the time period duration of the user interaction.

Providing for presentation at the user interface of pressure at the respective pressure sensors and the magnitude of the pressure received at each of the respective pressure sensors relative to the pressure profile corresponding to the threshold performance metric includes, in some embodiments, providing a graphical illustration of the handle portion of the device and the user interaction with the handle portion of the device. According to some embodiments, providing a graphical illustration of the handle portion of the device and the user interaction with the handle portion of the device includes: providing a graphical illustration of identified locations of the handle of the device where the user interaction with the handle portion of the device is determined to fail to correspond with the pressure profile corresponding to the threshold performance metric in manner that distinguishes the identified locations of the handle from a remainder of the handle.

### BRIEF DESCRIPTION OF DRAWINGS

Having thus described certain embodiments of the present disclosure in general terms, reference will now be made to the accompanying drawings, which are not necessarily drawn to scale, and wherein:

FIG. 1 illustrates an example device incorporating pressure sensors according to an example embodiment of the present disclosure;

FIG. 2 illustrates a detail view of the handle portion of the device of FIG. 1 including a pressure sensor array according to an example embodiment of the present disclosure;

FIG. 3 illustrates a detail view of the handle portion of the device of FIG. 1 including an indication of whether pressure received at a respective pressure sensor corresponds with a performance metric according to an example embodiment of the present disclosure;

FIG. 4 is a plot of pressure inputs received from fingers grasping a handle portion of a device according to an example embodiment of the present disclosure;

FIG. 5 illustrates a plurality of devices and handle portions thereof that may employ embodiments of the present disclosure;

FIG. 6 is a schematic diagram of a controller for controlling a device according to an example embodiment of the present disclosure; and

FIG. 7. illustrates a flowchart of a method according to an example embodiment of the present disclosure.

### DETAILED DESCRIPTION

The present disclosure now will be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

Embodiments provided herein include a human performance sensor software computational model that integrates pressure sensor data (e.g., grip pressure coordinates) synchronized with an outcome measure of performance (e.g., an inertial movement unit sensor). The data are synchronized on a time-series such that correlation can be demonstrated in the relationship between a particular map of pressure dynamics, such as location and amplitude of pressure, with the time series of events demonstrated by the outcome measure of performance, such as the precision and attenuation of movement in an inertial measurement unit (IMU) sensor.

Data is synchronized to flag unique events such that the rising edge, plateau, and slop off—return to trough are clearly windowed for correlation to the outcome measure of performance assessment. Flagged pressure behavior can be correlated on the time-series window with the precision of successful outcomes in the IMU sensor unit data. According to an example embodiment, events may be flagged based on a threshold, such as inclusion within the upper 5% of measured precision. Those unique events can then be analyzed to find the average pressure location and amplitude in the pressure sensor data. For example, a pressure profile map of those top 5% events. The top 5% pressure profiles will have a margin of error with a 95% confidence interval associated with pressure location and amplitude. Those average pressure coordinates then form a data library of optimal pressure for producing the upper 5% precision in the outcome measure of performance.

In some embodiments, the flagged pressure behavior is segmented into discrete temporal phases of the user interaction, and pressure data from selected phases is weighted more heavily than pressure data from other phases when correlating with the outcome measure of performance.

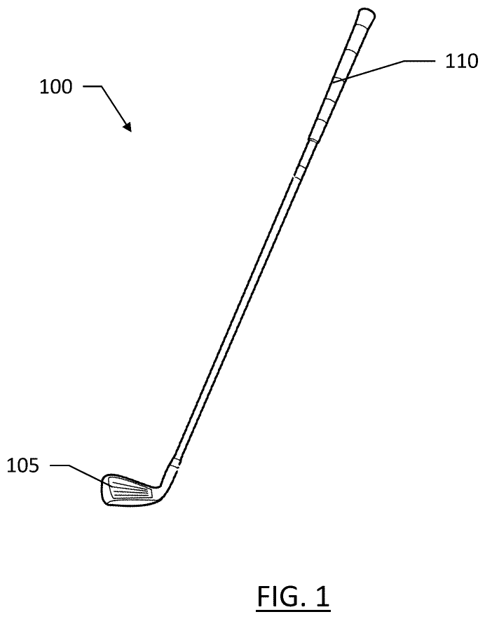

According to an example embodiment, an apparatus, such as a golf club or other hand-engaged implement, can be outfitted with pressure sensors covering the grip area of the club. FIG. 1 illustrates an example embodiment of such a golf club 100 with the grip 110 as a handle portion limited to a portion of the club. The size and distribution of the sensors may depend upon the specific sensors in use; however, they have sufficient fidelity to determine where a person's hands are gripping the golf club 100 and the pressure exerted by each contact point with the hands of the person. The pressure sensor data is read from the pressure sensors disposed around the grip 110 to measure the position and pressure of the person's hand during a swing of the golf club 100.

The golf club 100 of FIG. 1 further includes an IMU (inertial measurement unit) in the club head which may be employed to measure a golf swing. The IMU may determine a path of the club head, club head speed, swing plane, etc. These metrics measured by the IMU may be used as performance metrics to determine an ideal golf swing or together with a large sample size a superior golf swing (e.g., within the top 5% golf swings) based on the metrics measured.

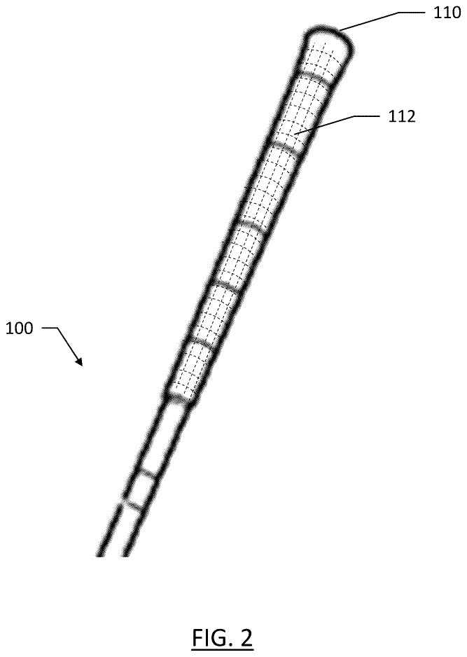

FIG. 2 illustrates an enlarged view of the grip 110 of the golf club 100 of FIG. 1. The grip 110 corresponds to a handle portion of the device, which is the golf club 100 in the illustrated embodiment. As shown, the grip 110 or handle portion is equipped with a plurality of sensors 112 that are arranged in a matrix within the grip 110. The sensors 112 may not extend throughout the grip 110 or handle portion of a device, but may instead be positioned or arranged proximate where proper gripping of the handle is performed.

The sensors 112 may be any of a variety of sensors capable of determining an amount of pressure applied to the handle portion. For example, the sensors may be strain gauges determining deformation of the handle, such as deformation in the rubberized portion of a grip 110. The sensors may be piezoresistive, capacitive sensors, piezoelectric, MEMS (Micro-Electro-Mechanical Systems), inductive/variable reluctance, or even optical sensors that detect pressure via changes in light transmission. Regardless of the type of sensor employed, embodiments employ sensors 112 that are capable of determining a pressure exerted at a specific location on the handle of the device for accurate determination of how the handle is grasped by a user.

Embodiments described herein determine locations on the handle portion receiving pressure at respective pressure sensors responsive to the user interaction in the form of grasping the device. Embodiments further determine a magnitude of the pressure received at each of the respective pressure sensors responsive to the interaction. In the example embodiment of FIGS. 1 and 2, this correlates to determining the grasping position and pressure of a golfer grasping the grip 110 of the golf club 100 ahead of a golf swing. The locations of the grip 110 or handle portion of the golf club 100 or device receiving pressure correspond to a golfer's grip of the grip 110 of the golf club 100. This provides an indication of if the golfer is grasping the grip 110 in the appropriate locations on the grip. The magnitude of the grasping force or pressure at each location on the grip 110 provides an indication of the force with which the grip 110 is grasped by the golfer.

Determining a position of the hands of a user grasping the grip 110 of the golf club 100 and the pressure applied at locations on the grip by the user grasping the grip of the golf club enable analysis of the user's overall grip position and pressure. This information can be compared against overall grip position and pressure employed by golfers with known outcomes of golf shots under those grip positions and pressures.

An outcome measure of performance for a swing of a golf club may include, for example, how true the swing is along a swing plane, how well a golf ball is struck, a club head speed, etc. Each of these metrics may be employed to identify the measure of performance of the swing. Various tools may be employed to establish the performance of a golf swing. For example, a golf club having a golf club head with an IMU 105 as described above may determine club head acceleration, club head speed, club head impact speed with a ball, and a path of the club head during a swing. Similarly, camera or image sensor tracking can provide similar stroke metrics associated with a golf swing. In addition to or alternative to golf swing metrics, the resultant golf shot associated with the golf swing can be used as a performance measure of a golf swing. The accuracy and precision of one or both of a golf swing or a resultant golf shot can be used to establish golf swings and resultant golf shots that satisfy a performance metric through accuracy and/or precision. Once the golf swing and/or resultant golf shot have been quantified relative to the performance metric, an analysis of the golf grip including hand/finger locations and associated pressures can be analyzed.

In the embodiment of a golf club, an event or swing can be flagged based on satisfying a performance metric, such as being in the top 5% of a determined performance metric (e.g., precision, accuracy, or a combination thereof). The grip position/locations and associated pressures of those golf swings satisfying the performance metric may be used as a guide for instructing a user as to how to grasp a golf club grip to improve the likelihood of a golf swing that satisfies the threshold performance metric.

The events determined to be in the top 5% (or any predetermined threshold which may vary depending upon the underlying foundational data) can then be used to identify an optimal pressure profile. An optimal pressure profile reflects a pressure profile that correlates with the events satisfying the predetermined threshold of optimal performance.

In some embodiments, the pressure profile corresponding to the threshold performance metric is iteratively refined as additional events satisfying the threshold performance metric are observed, thereby adapting the pressure profile over time.

The device, such as the aforementioned golf club, can be used to adjust a user's grip in real-time. A user may grip the device and apply pressure to the pressure sensor(s). The optimal pressure profile can be visually displayed on a display device, such as using a three-dimensional computer generated image (CGI) of the pressure sensor(s). The optimal pressure profile may be normalized as green when the user interacts with the pressure sensors and the pressure location and amplitude that corresponds with the optimal pressure profile. Visual feedback can be provided to reflect how far off of the optimal pressure profile a user has for a grip on the device.

Embodiments described herein provide synchronized visualization of pressure data, outcome sensor data, and video of the user interaction with the device. The computational model of example embodiments is agnostic to the specific application whether it involves grip pressure, stance-balance-gait, or respiratory pressure, and can integrate multiple outcome sensor modalities.

According to an example embodiment described herein, a corpus of outcomes from a particular event, whether athletic or otherwise having a measurable outcome, may be established including performance attributes that enable a determination of what is deemed an ideal performance. For example, with a golf swing, a hole-in-one may be determined to be an ideal performance of a golf swing with an ideal outcome if the end of the golf shot is used to establish an ideal performance. However, a hole-in-one may result from a fortunate bounce or other hole-specific anomaly that aids the resultant shot. As such, the golf swing analysis may be used to establish ideal performance, where club head speed, club head location relative to the golf ball, swing plane, etc. may contribute to the ideal performance metric. Regardless of the metrics employed, an ideal performance is determined based on performance metrics. To establish a threshold performance metric, some degree of similarity with the ideal performance of the event is established. For example, a threshold performance metric may be determined to be if the performance of the event is within 5% of the ideal performance metric. The factors contributing to the ideal performance and the weighting of any factors (e.g., club head speed or club head location striking the ball) may factor into the ideal performance. However, for purposes described below, the ideal performance and the threshold performance metric is employed as a binary determination. Pressure profiles may be derived from population-level data, individualized user data, or a combination thereof.

Upon establishment of a threshold performance metric, embodiments described herein can provide real-time feedback regarding a user's interaction with a handle portion of a device. Referring again to the embodiment of FIGS. 1 and 2, the user interaction with a handle portion of a device may include a user grasping the grip 110 of a golf club 100. The sensors 112 depicted in FIG. 2 may identify locations on the handle portion or grip 110 receiving pressure from the user's grip, and the sensors 112 may identify a magnitude of the pressure received at each of the sensors responsive to the grip. The user's grip of the grip 110 of the golf club 100 may be identified as a grip profile including both the locations and pressures of the grip determined from the sensors 112. This profile may be compared against pressure profiles or gripping profiles of the grip 110 of golf clubs 100 associated with events, in this case golf club swings, that satisfy a threshold performance metric (e.g., within 5% of an ideal performance).

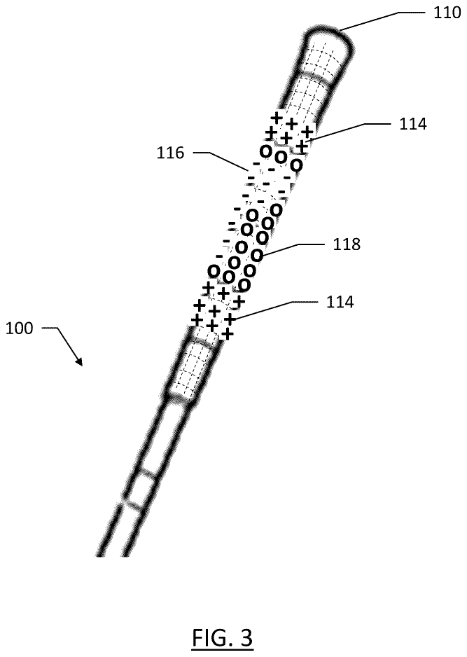

In making the comparison between the user's grip and the existing grip profiles of events that satisfy the threshold performance metric, feedback may be provided to the user. This feedback may be in the form of a graphical user interface such as a display that presents feedback to the user. FIG. 3 illustrates an example embodiment of such a graphical user interface showing the grip 110 of FIG. 2 with pressure indications depicted on the various locations of the grip corresponding to the user's grip. The depicted embodiment shows “+” plus signs where grip pressure is above a pressure used for a golf swing event satisfying the threshold performance metric. The depicted embodiment further illustrates “−” minus signs where grip pressure is below a pressure used for golf swing events satisfying the threshold performance metric. A “o” illustrates a location on the grip 110 where the grip pressure is within the range satisfying the threshold performance metric. While depicted as symbols, in an alternative embodiment, the grip pressure relative to the grips associated with the threshold performance metric may be shown in colors, such as red for too high a pressure applied, yellow for too low a pressure applied, and green for appropriate pressure.

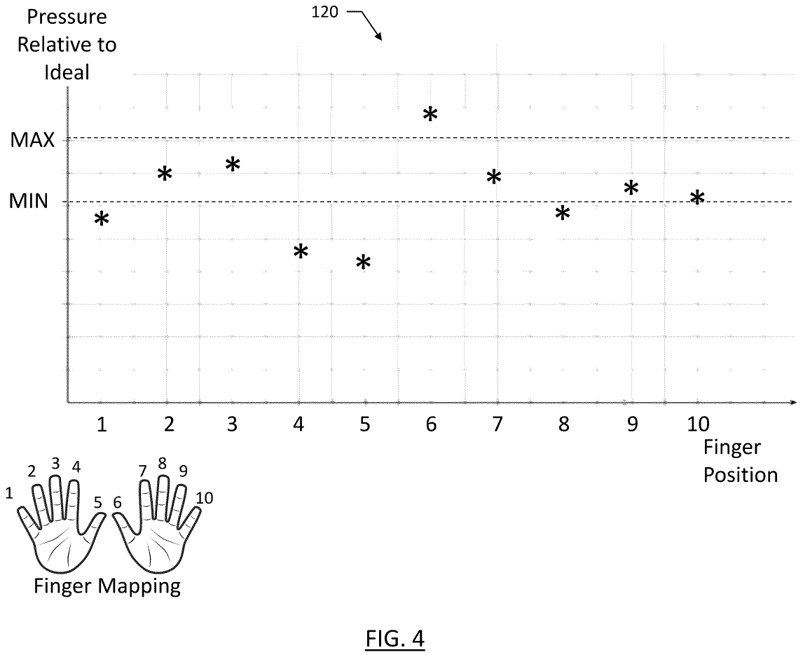

FIG. 4 illustrates another user interface that provides an indication of user interaction with a handle portion of a device. The user interface of FIG. 4 may be employed with the embodiment of the golf club 100 of FIGS. 1-3 or employed with any other embodiments described herein. As shown, each finger of a user's hand may be assigned a number based on the finger mapping illustrated. Each finger may also correspond to a vertical line on the chart 120 along the X-axis. The Y-axis reflects a pressure, which in the illustrated embodiment may be normalized to have the minimum and maximum pressures corresponding to a threshold performance metric lie between two lines. As a user interacts with the handle portion of a device, the grip pressure may be sensed and plotted for each finger along its respective vertical line. According to the illustrated embodiment of FIG. 4, Finger 1 has a pressure slightly below the goal pressure between the MIN and MAX. Finger 8 is similarly slightly below the MIN pressure line. Fingers 4 and 5 are considerably further below the MIN pressure line. This indicates to a user that they must apply more pressure with Fingers 1, 4, 5, and 8. Fingers 2, 3, 7, 9, and 10 are each within the goal pressure between the MIN and MAX pressure to satisfy the threshold performance metric. Finger 6 is applying too much pressure, such that the grip of Finger 6 should be loosened to reach a goal pressure.

While the pressure relative to the ideal pressure shown in FIG. 4 has been normalized across each finger, such normalization is not necessary. In some embodiments, a graphical representation of the hands themselves may be presented with color coded graphics over the fingers and palms representing if more or less pressure is to be applied. Such an embodiment may provide an intuitive process to determine how to achieve interaction with the handle portion of a device in a manner corresponding to satisfaction of a threshold performance metric.

In each scenario described above, the grip or user interaction with a handle portion of the device is not a static event. The user interaction with the handle portion of the device is generally an interaction that occurs over a period of time, and that period of time is a duration of the interaction between the user and the handle portion of the device. For example, in the embodiment of a golf club grip, the event includes a user interaction with the handle portion (grip 110) of the device (golf club 100) over the course of the event (golf swing). The time period duration of the event and user interaction is the duration of the swing from initial grasp, through back swing, and through contact between the golf club and the golf ball. To that end, FIGS. 3 and 4 represent static moments in time, which could be at any point during the duration of the user interaction.

As the user interaction occurs over the time period duration of the event, the grip may change during the event. A user may tighten a grip at certain points of the event, or relax the grip at other points of the event. Some events such as a golf swing may occur relatively quickly, such that a user cannot feasibly watch the graphical user interface depicting their grip pressure and location relative to ideal while swinging the golf club. As such, the user interaction with the handle of the device may be recorded for the duration of the event for replay to benefit a user and to provide coaching. This graphical user interface depicting the user interaction through the event may be beneficial to a user. However, it may be particularly beneficial to the user if paired with a synchronized video of the event, particularly one in which a user may pause the event. The replay may include synchronized visualization of pressure data, outcome sensor data, and video of the user interaction.

During a golf swing, a user may watch their grip location and pressure on a user interface such as a video display while a video of their golf swing is also displayed. The user may watch their interaction with the grip and when the graphical user interface displays an interaction of interest (e.g., the user's interaction with the handle is very far from ideal or the user's interaction is very close to ideal), the user may slow or stop the video and the synchronized display of user interaction pressure locations and magnitudes. This may enable the user to better analyze what may be occurring that causes the user to perform as depicted on the user interface.

The graphical user interface may render a computer generated image of the handle portion of the device in two or three dimensions during the event such that a user can manipulate the handle portion (e.g., zoom in/out, pan, rotate, etc.) to review the various locations where they are gripping or not gripping the handle. This can be done during review of a completed event (e.g., with the video described above) or in real-time as a user is interacting with the handle portion of the device. This computer generated image of the handle portion of the device enables the user to interact with the sensors of the handle portion of the device in real-time as they manipulate their interaction and alter pressures to understand the appropriate grip position and associated pressures.

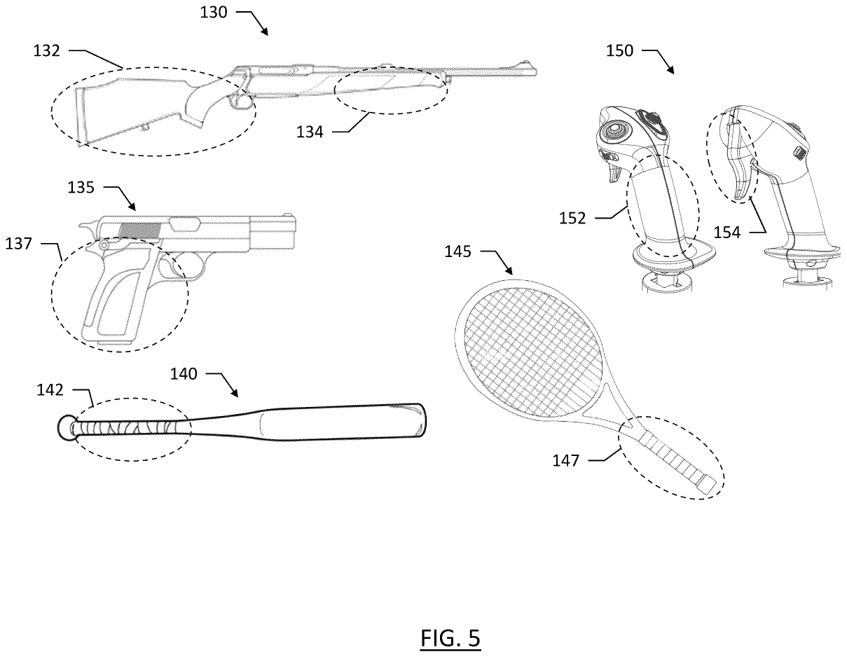

While FIGS. 1-3 illustrate an example embodiment of a device with a handle portion for user interaction in the form of a golf club 100 with a grip 110, embodiments described herein relate to various types of devices not limited to sports equipment. FIG. 5 illustrates various embodiments of devices that include handle portions that a user interacts with to achieve a particular goal which can be measured against performance metrics as described above.

As shown in FIG. 5, a rifle 130 may employ embodiments of the present disclosure, such as with sensor arrays in the stock, pistol grip, and trigger shown within boundary 132 and the forestock shown within boundary 134. These locations may include sensor arrays as the way in which a user interacts with these handle portions of the device in the form of rifle 130 impact performance. With the rifle 130, performance may be more easily measured through accuracy of a target that is shot with the rifle. Similarly, a pistol 135 may benefit from embodiments described herein with a sensor array positioned on the pistol grip and trigger shown within border 137.

In one representative embodiment, a device such as the rifle 130 or pistol 135 may be equipped with a sensor suite, such as a Shoot-Move-and-Communicate (SMAC) sensor suite. SMAC sensor suite constitutes a physical instantiation of the Deliberate Practice and Feedback (DPAF) computational architecture described herein. In such embodiments, SMAC provides a tangible sensor-level implementation in which pressure sensors, inertial movement units, and optional recoil or force-simulation components collectively function as a physical observability layer. The DPAF computational model operates as an abstraction layer that time-synchronizes physical contact data with outcome measures of performance, identifies statistically significant performance-correlated events, and generates feedback signals for guiding subsequent user interaction. While SMAC is described in the context of marksmanship training, it is to be understood that SMAC is exemplary rather than limiting, and that the DPAF architecture is application-agnostic and may be instantiated across a wide range of human-equipment interaction domains.

The SMAC sensor suite may be time synchronized and provided for presentation to a user such that the user understands their interaction with the pressure sensors and the feedback signals in the form of movement of the firearm to inform how the applied pressure at the locations handled by the user result in certain types and magnitudes of motion. This enables a user to adjust their grip position and pressure while realizing real-time feedback as to how the adjusted grip and pressure alters the feedback motion of the firearm.

Another example shown in FIG. 5 is a bat 140 which may be a baseball bat, softball bat, cricket bat, or the like. In each embodiment, the handle shown in boundary 142 may be equipped with a sensor array to identify grip locations and pressure on the handle relative to a pressure profile corresponding to events satisfying the threshold performance metric. A tennis racket 145 may be similarly instrumented with sensors on a handle shown within boundary 147. In another example embodiment, a flight control stick 150 may be equipped with sensors as described above within the handle portion shown within boundary 152 and a trigger portion shown within boundary 154. The user interaction measured at positions and pressures of the flight control stick 150 may be measured during high-stress scenarios such as while experiencing G-forces, while landing, while in combat or training, etc. to identify how a pilot is interacting with the flight control stick 150 and to determine if there is a better manner of interaction for the pilot.

According to some embodiments described herein, the sensors of the handle portion of a device may be configured to provide an alert if an abnormal interaction is detected. In an example embodiment in which the device is a flight control stick 150 of FIG. 5 or a steering wheel of a vehicle, the user interaction with the device may be measured at locations and pressures. Certain grasping positions and pressures may be associated with an anomaly, such as fatigue, a medical condition, or other issues that may cause a user to lose focus of their interaction with the flight control stick or steering wheel. In such scenarios, an alert may be provided to the user or to another party to intervene in the operation of a vehicle with a user experiencing such issues.

Embodiments of the present disclosure provide a pressure sensitive training apparatus which includes a device that has a handle portion that a user grasps. The device is configured to cause an action responsive to the user interaction with the handle portion of the device. This action can include a golf swing, a target shot, a swing of a bat or racket, or control of a flight control stick as described above. A plurality of sensors are arranged about the handle portion to sense locations of the handle portion that receive pressure from a user and a magnitude of pressure at each of the sensors. The pattern of the grip of the handle and the pressure exerted at the various sensors contacted may be compared against pressure profiles. Pressure profiles generated based on a performance metric of the action that the device is caused to perform by a user are used to determine if the user's grip of the handle corresponds with a pressure profile corresponding to a threshold performance metric. The delta between the user's grip and the pressure profile corresponding to the threshold performance metric may be provided for display via a graphic user interface to enable a user to adjust their grip of the handle either in real-time or on subsequent interactions with the device.

According to an example embodiment, a user may grasp the device about the pressure sensors and if the user's hands are in the wrong orientation or position, the pressure points that are seeing pressure may show up in red on a display of a CGI representation of the device. As the user moves their hands around the device, the pressure sensors may ebb to yellow and eventually to green as a user finds the proper position that corresponds to the optimal pressure profile. In such an embodiment, red may indicate insufficient pressure or too much pressure by a considerable margin, while yellow may indicate pressure that is closer to an ideal pressure. Green signifies that the pressure corresponds with that of a pressure profile corresponding to a minimum threshold performance metric. Once the hands are in the appropriate positions about the pressure sensors of the device, the force (amplitude) of the pressure of the user's grip may be adjusted. The appropriate amplitude of the grip force for the optimal pressure profile may be provided on the display by a brighter green color, or by an intensity or brightness of a location on the device corresponding to where the pressure amplitude is correct. This process allows a user to view their grip pressure profile in real-time, and adjust that grip pressure profile until it is within a predetermined degree of the optimal pressure profile.

The predetermined degree within which a user may be within the optimal pressure profile may be based on a statistical analysis of the pressure profiles of the events having outcomes that satisfy the predetermined threshold (e.g., top 5%). The pressure profiles associated within those events will have some degree of variation, such that there can be included a margin of error within which the optimal pressure profile exists.

Embodiments described herein provide a computational model to integrate the pressure sensor data in the form of grip pressure coordinates with an outcome measure of performance based on analysis of a time-synchronized pressure profile with measured outcome of performance. The computational model described herein can be agnostic to the application use case of pressure and is not limited to the golf club example described above. Conversely, the use case of pressure can include a grip pressure profile, a stance-balance-gait pressure profile, a respiratory pressure profile on a thoracic excursion, an impact surface pressure profile, etc. In some embodiments, multiple outcome sensor modalities are time-synchronized with the pressure sensor data to jointly determine correspondence with the threshold performance metric.

The computational model described herein is also agnostic to the application use case of outcome measure of performance. It could include an inertial movement unit sensor, a laser guide, an acoustic sensor, a reaction time/movement time sensor, a smart target precision sensor, etc.

The graphical user interface is also agnostic to the feedback system for the end user. The GUI will render the computer generated image of the pressure sensor such that the end user can interact with the sensor in real time and have the top 5% precision in outcome measure of performance as indicated by the CGI representation of the pressure sensor. For example, a 3D grip image will normalize as optimal when the pressure location and amplitude are achieved in the analyzed top 5% of time-series correlated outcome measure of performance in an IMU sensor behavior.

Human performance benefits from a deliberate practice and feedback (DPAF) system for optimal skill acquisition and refinement. This model can be employed for tactile grip of various devices in wide ranging scenarios. For example, grip pressure detection of a steering wheel under fatigue, aviation cockpit control manipulation under G-force and complexity, explosive ordinance material manual neutralization under time compression, or protective force marksmanship with rifle performance under emotional stress, for example. Embodiments can be applied to the sports environment such as with a baseball bat swinging, ball throwing, soccer ball shoe kicking, marathon shoe running, javelin throwing, pole vaulting grip, golf club grip and swing, etc. The computational model described herein can address almost any human factors in outcome measure of performance with which a human interacts physically with a piece of equipment by applying pressure as described herein. In some embodiments, deviations from baseline pressure profiles are associated with fatigue, stress, or abnormal user states, and trigger alerts or interventions.

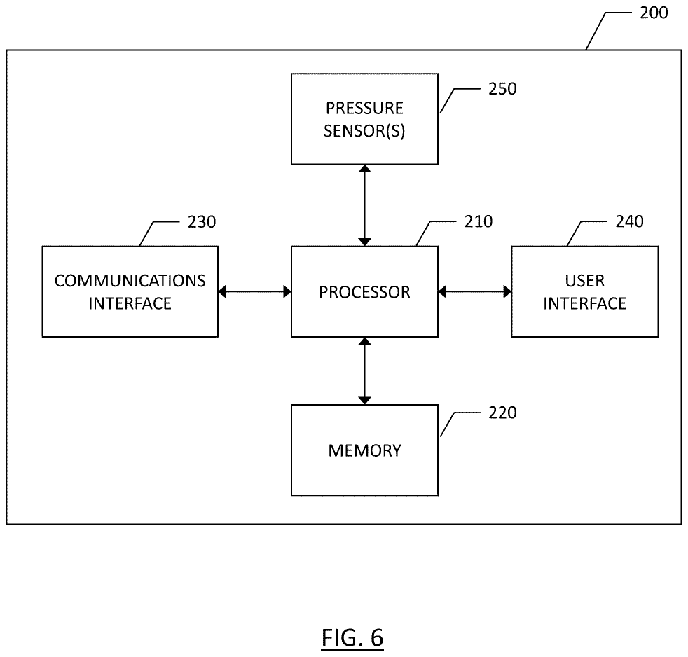

FIG. 6 is a schematic diagram of an example of a controller 200 that may be used to control the device including the one or more pressure sensor(s) 250 described herein. The controller 200 may include or otherwise be in communication with a processor 210, a memory 220, a communication interface 230 and a user interface 240. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 210 (and/or co-processors or any other processing circuitry assisting or otherwise associated with the processor) may be in communication with the memory 220 via a bus for passing information among components of the apparatus. The memory 220 may include, for example, one or more volatile and/or non-volatile memories. In other words, for example, the memory 220 may be an electronic storage device (e.g., a computer readable storage medium) comprising gates configured to store data (e.g., bits) that may be retrievable by a machine (e.g., a computing device like the processor). The memory 220 may be configured to store information, data, content, applications, instructions, or the like for enabling the pressure sensors 250 to sense a location and amplitude of pressure in accordance with an example embodiment of the present disclosure. For example, the memory 220 could be configured to buffer input data for processing by the processor 210. Additionally or alternatively, the memory 220 could be configured to store instructions for execution by the processor, such as for controlling the pressure sensors 250 described above.

The processor 210 may be embodied in a number of different ways. For example, the processor 210 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 210 may include one or more processors configured in tandem via the bus to enable independent execution of instructions, pipelining and/or multithreading. The processor may be embodied as a microcontroller having custom bootloader protection for the firmware from malicious modification in addition to allowing for potential firmware updates.

In an example embodiment, the processor 210 may be configured to execute instructions stored in the memory 220 or otherwise accessible to the processor 210. Alternatively or additionally, the processor 210 may be configured to execute hard coded functionality. As such, whether configured by hardware or software methods, or by a combination thereof, the processor 210 may represent an entity (e.g., physically embodied in circuitry) capable of performing operations according to an embodiment of the present disclosure while configured accordingly. Thus, for example, when the processor 210 is embodied as an ASIC, FPGA or the like, the processor 210 may be specifically configured hardware for conducting the operations described herein. Alternatively, as another example, when the processor 210 is embodied as an executor of software instructions, the instructions may specifically configure the processor 210 to perform the algorithms and/or operations described herein when the instructions are executed. However, in some cases, the processor 210 may be a processor of a specific device (e.g., a head-mounted display for extended reality) configured to employ an embodiment of the present disclosure by further configuration of the processor 210 by instructions for performing the algorithms and/or operations described herein. The processor 210 may include, among other things, a clock, an arithmetic logic unit (ALU) and logic gates configured to support operation of the processor 210. In one embodiment, the processor 210 may also include user interface circuitry configured to control at least some functions of one or more elements of the user interface 240.

The communication interface 230 may include various components, such as a device or circuitry embodied in either hardware or a combination of hardware and software that is configured to receive and/or transmit data for communicating to and from the device, such as the golf club 100. In this regard, the communication interface 230 may include, for example, an antenna (or multiple antennas) and supporting hardware and/or software for enabling communications wirelessly. Additionally or alternatively, the communication interface 230 may include the circuitry for interacting with the antenna(s) to cause transmission of signals via the antenna(s) or to handle receipt of signals received via the antenna(s). For example, the communication interface 126 may be configured to communicate wirelessly such as via Wi-Fi (e.g., vehicular Wi-Fi standard 802.11p), Bluetooth, mobile communications standards (e.g., 3G, 4G, or 5G) or other wireless communications techniques.

The user interface 240 may be in communication with the processor 210, such as the user interface circuitry, to receive an indication of a user input and/or to provide an audible, visual, mechanical, or other output to an operator. As such, the user interface 240 may include, for example, one or more buttons, light-emitting diodes (LEDs), a mounted display (e.g., display), a speaker, and/or other input/output mechanisms. The user interface 230 may also be in communication with the memory 220 and/or the communication interface 230, such as via a bus. The user interface 240 may include an interface that responds to physical contact (e.g., buttons, switches, etc.). While a display device may display a user interface 230 as described above, according to some embodiments, the user interface may be incorporated into the device, such that the device itself provides feedback to a user of the optimal pressure profile when it is achieved by a user. This could be in the form of LEDs, audio, or the like that signify when a user has achieved the optimal pressure profile.

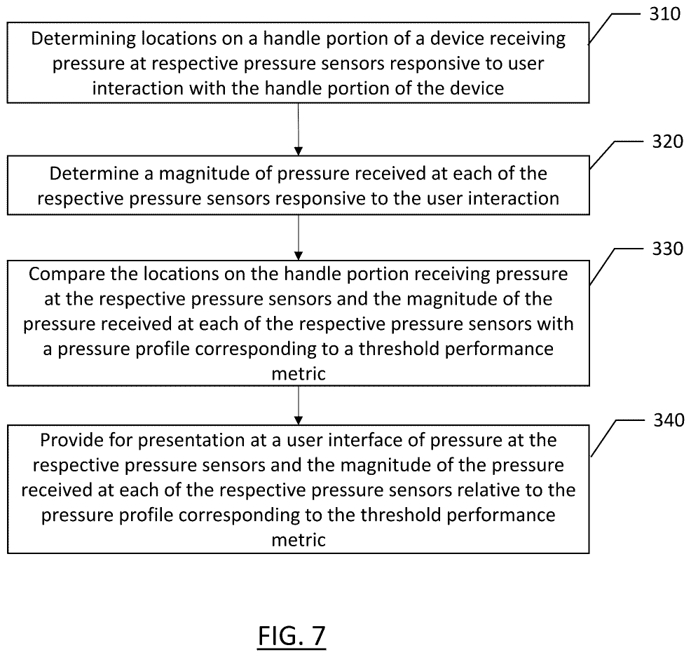

FIG. 7 illustrates a flowchart of a method according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 220 of an apparatus employing an embodiment of the present invention and executed by the processor 210 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks and/or other method steps described herein.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions (including firmware, software, and/or configurable logic).

According to the flow chart of FIG. 7, a process is provided for integrating pressure sensor data synchronized with an outcome measure of performance. As shown at 310, locations on a handle portion of a device receiving pressure at respective pressure sensors are determined responsive to user interaction with the handle portion of the device. A magnitude of pressure received at each of the respective pressure sensors responsive to the user interaction is determined at 330. The pressure at the respective pressure sensors and the magnitude of the pressure received at each of the respective pressure sensors relative to the pressure profile corresponding to the threshold performance metric is provided for presentation at 340 on a user interface, such as on a digital display, such that a user can observe real time feedback regarding their grip position and pressure.

In an example embodiment, an apparatus for performing the method of FIG. 7 above may comprise a processor (e.g., the processor 210) configured to perform some or each of the operations (310-340) described above. The processor may, for example, be configured to perform the operations (310-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-340 may comprise, for example, the processor 210 and/or a device or circuit for executing instructions or executing an algorithm for processing information as described above including lock-in demodulation, normalization, and calibration-based concentration estimation.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation unless expressly stated otherwise. In one best-mode embodiment, the system comprises a rifle grip instrumented with pressure sensors, an inertial measurement unit for outcome measurement, and a graphical user interface providing real-time and replay feedback .

1. A pressure sensitive training apparatus comprising:
a handle portion of a device, wherein the device is configured to cause an action responsive to a user interaction with the handle portion of the device;
a plurality of pressure sensors disposed about the handle portion of the device; and
a controller, wherein the controller is configured to:
determine locations on the handle portion receiving pressure at respective pressure sensors responsive to the user interaction;
determine a magnitude of pressure received at each of the respective pressure sensors responsive to the user interaction;
compare the locations on the handle portion receiving pressure at the respective pressure sensors and the magnitude of the pressure received at each of the respective pressure sensors with a pressure profile corresponding to a threshold performance metric; and
provide for presentation at a user interface of pressure at the respective pressure sensors and the magnitude of the pressure received at each of the respective pressure sensors relative to the pressure profile corresponding to the threshold performance metric.

2. The apparatus of claim 1, wherein the user interaction with the handle portion of the device comprises an action performed by a user while grasping the handle portion of the device.

3. The apparatus of claim 2, wherein the device comprises a piece of athletic equipment or other hand-operated device, and wherein the user interaction comprises swinging, actuating, or manipulating the device.

4. The apparatus of claim 3, wherein the threshold performance metric comprises a measure of performance that corresponds with an athletic event above a predetermined precision.

5. The apparatus of claim 4, wherein the athletic event above a predetermined precision comprises an athletic event having a result that is within the predetermined precision of an athletic event identified as ideal.

6. The apparatus of claim 1, wherein the controller configured to determine the locations on the handle portion receiving pressure at respective pressure sensors responsive to the user interaction is further configured to determine the locations over a time period duration of the user interaction.

7. The apparatus of claim 6, wherein the controller configured to determine the magnitude of pressure received at each of the respective pressure sensors responsive to the user interaction is further configured to determine the magnitude over the time period duration of the user interaction.

8. The apparatus of claim 7, wherein the controller configured to provide for presentation at the user interface is further configured to provide the presentation over the time period duration of the user interaction.

9. The apparatus of claim 8, wherein the controller is further configured to segment pressure data associated with the user interaction into a plurality of temporal phases over the time period duration of the user interaction, and to correlate pressure data from at least one of the plurality of temporal phases more heavily with the threshold performance metric than pressure data from another of the plurality of temporal phases.

10. The apparatus of claim 9, wherein the controller is further configured to update the pressure profile corresponding to the threshold performance metric based on pressure data associated with subsequent user interactions that satisfy the threshold performance metric.

11. The apparatus of claim 1, wherein the controller configured to provide for presentation at the user interface is further configured to provide a graphical illustration of the handle portion of the device and the user interaction with the handle portion of the device.

12. The apparatus of claim 11, wherein the controller configured to provide the graphical illustration is further configured to distinguish identified locations of the handle portion where the user interaction fails to correspond with the pressure profile corresponding to the threshold performance metric.

13. The apparatus of claim 1, wherein an outcome measure of performance comprises a plurality of heterogeneous sensor modalities, and wherein the controller is configured to time-synchronize pressure data with data from at least two different sensor modalities when determining correspondence with the threshold performance metric.

14. The apparatus of claim 13, wherein the user interface is further configured to present a replay of the user interaction synchronized with pressure data and the outcome measure of performance.

15. The apparatus of claim 1, wherein the controller is further configured to detect a deviation of pressure data from a baseline pressure profile indicative of user degradation and to generate an alert responsive to the deviation.

16. A method comprising:
determining locations on a handle portion of a device receiving pressure at respective pressure sensors responsive to a user interaction with the handle portion of the device;
determining a magnitude of pressure received at each of the respective pressure sensors responsive to the user interaction;
comparing the locations on the handle portion receiving pressure at the respective pressure sensors and the magnitude of the pressure received at each of the respective pressure sensors with a pressure profile corresponding to a threshold performance metric; and
providing for presentation at a user interface of pressure at the respective pressure sensors and the magnitude of the pressure received at each of the respective pressure sensors relative to the pressure profile corresponding to the threshold performance metric.

17. A non-transitory computer-readable medium storing instructions that, when executed by one or more processors, cause the one or more processors to perform the method of claim 16.

18. The method of claim 16, wherein the user interaction with the handle portion of the device comprises an action performed by a user while grasping the handle portion of the device.

19. The method of claim 18, wherein the device comprises a piece of athletic equipment, wherein the user interaction comprises swinging the device, or wherein the device comprises a non-athletic hand-operated device.

20. The method of claim 19, wherein the threshold performance metric comprises a measure of performance that corresponds with an athletic event above a predetermined precision.

21.-28. (canceled)
